(19) United States
(12) Patent Application Publication
(10) Pub. No.: US 2010/0057987 A1
(43) Pub. Date: Mar. 4, 2010

(54) Method and System for Upgrading Normal Disk Controller to RAID Controller

(76) Inventor: Guanglin Liu, Natick, MA (US)

Correspondence Address: Guanglin Liu, 24 Winter Street, Natick, MA, 01760, US

(21) Appl. No.: 12/204,343

(22) Filed: Sep. 4, 2008

(51) Int. Cl. G06F 12/00

(52) U.S. Cl. 711/114; 711/E12.001

(57) ABSTRACT

The invention provides a method and system for upgrading Normal Disk Controller to RAID (Redundant Array of Independent Disks) Controller. Unlike Normal Disk Controller that reports the exact physical disks to Host Computer System, the RAID Controller only reports the configured RAID Logical Units. According to different RAID configurations, the RAID Controller might increase data availability and storage capacity, improve system performance and flexibility, and realize data protection and recovery. The disclosed method and system for upgrading includes three parts: RAID BIOS (Basic Input/Output System) Initialization and Configuration, OS (Operate System) Driver, and Application Program, and the Controller after upgrading will behave exactly like a RAID Controller, at BIOS level, OS level, and Application level.

### BACKGROUND OF INVENTION

1. Field of Invention

The present invention relates generally to computer systems and specifically to mass storage computer system with RAID (Redundant Array of Independent Disks) Controller.

2. Description of the Related Art

The mass storage computer systems with RAID Controller are well known in the art. According to different RAID configurations, the RAID Controller might increase data availability and storage capacity, improve system performance and flexibility, and realize data protection and recovery, etc. Basically, the way to get a RAID Controller for a computer system is to insert a Hardware RAID Card into the system so that the system could get the all benefits of RAID. The computer system with Normal Disk Controller cannot realize any RAID function, so it couldn't benefit anything of RAID.

The present invention provides a method for upgrading the Normal Disk Controller to RAID Controller. The Controller after upgrading will behave exactly like a RAID Controller, take the whole benefits of RAID, and more importantly, needn't any expensive RAID Card.

### SUMMARY OF THE INVENTION

The present invention provides a method and system for upgrading Normal Disk Controller to RAID Controller. Unlike Normal Disk Controller who reports the exact physical disks to Host Computer System, the RAID Controller only reports the configured RAID Logical Units. According to different RAID configurations, the RAID Controller might increase data availability and storage capacity, improve system performance and flexibility, and realize data protection and recovery.

In order to make the Controller after upgrading behave exactly like a RAID Controller, the present invention provides a method that the Controller will handle any command, no matter whether the command is from BIOS (Basic Input/Output System) level or from Operate System level, exactly the same way as the RAID Controller handles the command.

For the BIOS level commands, the BIOS interrupt INT 13h is the only way to provide Low Level Disk services for the system. The present invention uses a way to hook up the BIOS interrupt INT 13h to a new program so that all Low Level Disk services will be handled exactly like what the RAID Controller handles. Since the new ST 13h program will be placed in the EBDA (Extended BIOS Data Area) memory, the disclosed invention also hooks up the BIOS interrupt INT 15h for E820 function.

For the Operate System level commands, the Driver for the Controller will handles all commands. The present invention provides the Driver for the Controller that will make the Controller handle all commands like a RAID Controller.

Furthermore, the present invention also provides the RAID Configuration and Application Program, which will let users to finish any function that a Hardware RAID Card can do and more.

In a word, with the present invention, the Controller after upgrading will behave exactly like a RAID Controller, take the whole benefits of RAID, and more importantly, needn't any expensive RAID Card.

### BRIEF DESCRIPTION OF THE DRAWINGS

FIG. 1 shows an example of a computer system with Normal Disk Controller, wherein three Physical Disks are connected and detected by the system.

FIG. 2 shows the same computer system as FIG. 1 with the RAID Controller, upgraded from the Normal Disk Controller, wherein three Physical Disks are connected, while four RAID Logical Units will be detected and used by the system.

FIG. 3 is a block diagram illustrating how a computer system with Normal Disk Controller provides the Low Level Disk services at BIOS Level via INT 13h.

FIG. 4 shows the ways of the present invention how to upgrade a computer system with Normal Disk Controller to the system with RAID Controller at BIOS Level.

FIG. 5 is a block diagram illustrating how a computer system with RAID Controller, upgraded from the Normal Disk Controller, provides the Low Level Disk services at BIOS Level via AT 13h.

FIG. 6 is a block diagram illustrating how a computer system with Normal Disk Controller handles the commands of Disk services at Operate System Level via Driver.

FIG. 7 is a block diagram illustrating how a computer system with RAID Controller, upgraded from the Normal Disk Controller through the Driver of the present invention, handles the commands of Disk services at Operate System Level.

FIG. 8 is a table illustrating RAID Configuration Menu and Functions of the present invention.

FIG. 9 is a table illustrating the Application Program Menu and Functions of the present invention.

### DETAILED DESCRIPTION OF THE PREFERRED EMBODIMENT

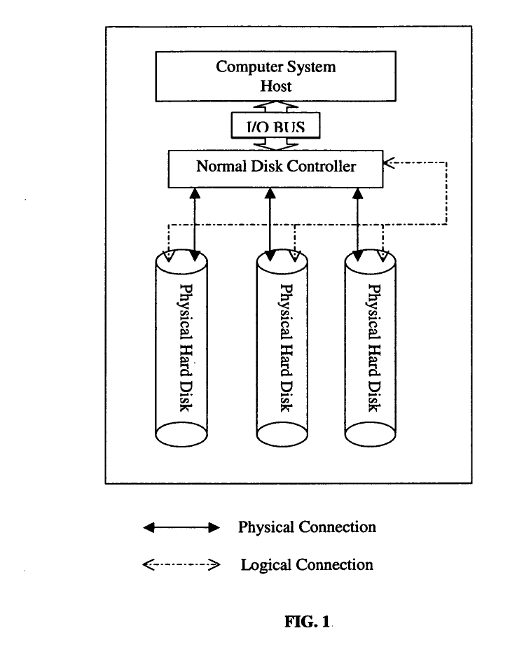

FIG. 1 shows an example of a computer system with Normal Disk Controller. In this system, three Physical Disks are connected to the Normal Disk Controller through the specific physical cables. The Normal Disk Controller can scan the physical disks, detect the parameters of each physical disk, send I/O commands to the physical disks and receive the responses. When the host computer system inquires how many disks connected, the Normal Disk Controller will report these physical disks as the Logical Drives to Host. Therefore, the physical disks matches exactly with the Logical Drives in the system. Any command that host computer system sends to Logical Drives will be sent to respective physical disk directly, and the response from this physical disk will report back to host without any change. So, the computer system with Normal Disk Controller knows nothing about RAID, and it wouldn't benefit anything of RAID either.

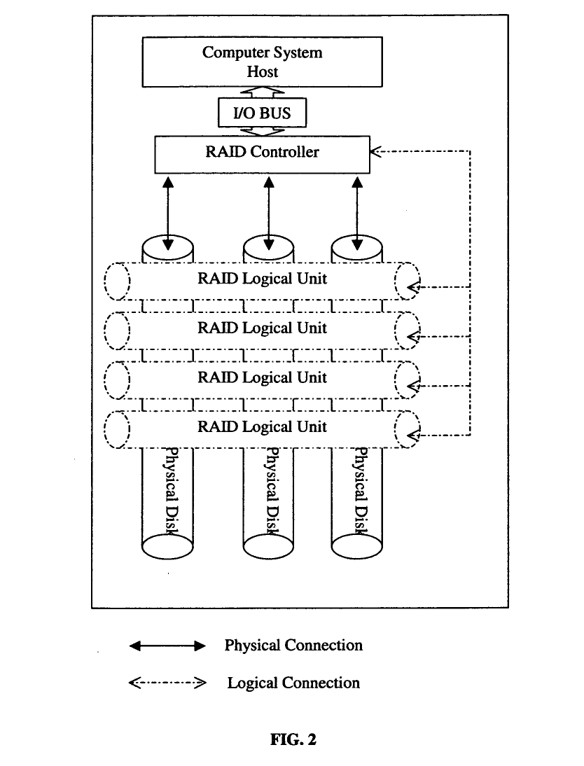

FIG. 2 shows the same computer system as FIG. 1 with the RAID Controller upgraded from the Normal Disk Controller via the way provided by the present invention. In this system, three Physical Disks are connected to the Controller through the specific physical cables, as the computer system of FIG. 1, while the Controller has been upgraded to RAID Controller. And in the RAID DDF (Disk Data Format) Structure on the Physical Disks, four RAID Logical Units as an example have been set up. Like the Normal Disk

Controller, the RAID Controller can also scan the physical disks, detect the parameters of each physical disk, send I/O commands to the physical disks, and receive the responses. On the other hand, the RAID Controller will read the RAID DDF Structure from the physical disks if there is a valid one and load the RAID Configuration information. Therefore, when the host computer system inquires how many disks connected, the RAID Controller will report four Logical Drives rather than three physical disks to Host. Any command that host computer system sends to Logical Drives will be handled by the RAID Controller. Based on the RAID Configuration information, the RAID Controller will analyze the command first, then send the commands to all related physical disks if it is necessary, process the responses received from physical disks, and send the final result back to host So, the RAID Controller can realize all RAID functions and have all benefits of RAID.

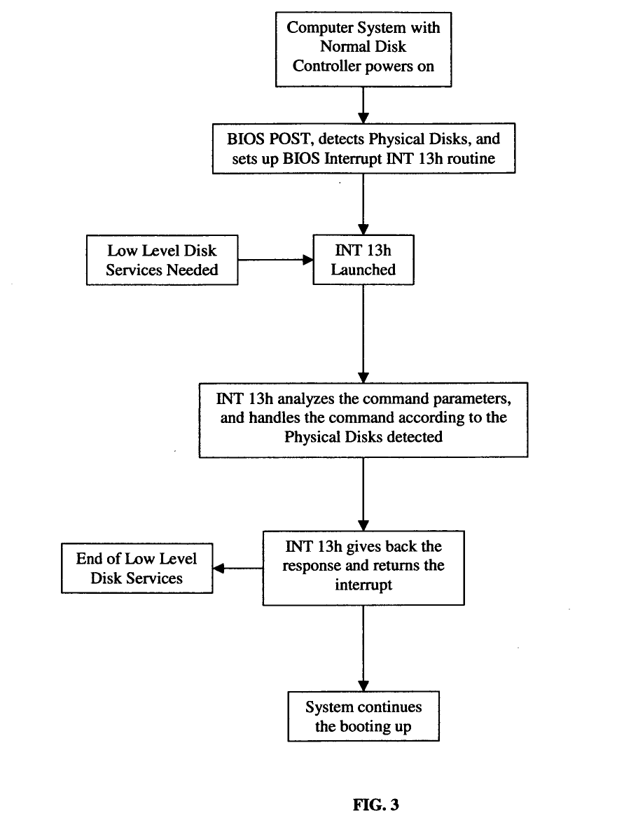

FIG. 3 illustrates how a computer system with Normal Disk Controller provides the Low Level Disk services at BIOS level via INT 13h. After the computer system with Normal Disk Controller powers on, the BIOS POST (Power On and Self Test) will take the control first. The BIOS will detect the physical disks connected and set up BIOS Interrupt INT 13h routine according to the detecting results. If there is any Low Level Disk service needed, the only way to do it is to call INT 13h to send the command and get the response. The BIOS Interrupt INT 13h routine will analyze the command parameters, send the command to physical disks detected, get the responses, set up the return value, and return the interrupt to finish the Low Level Disk service.

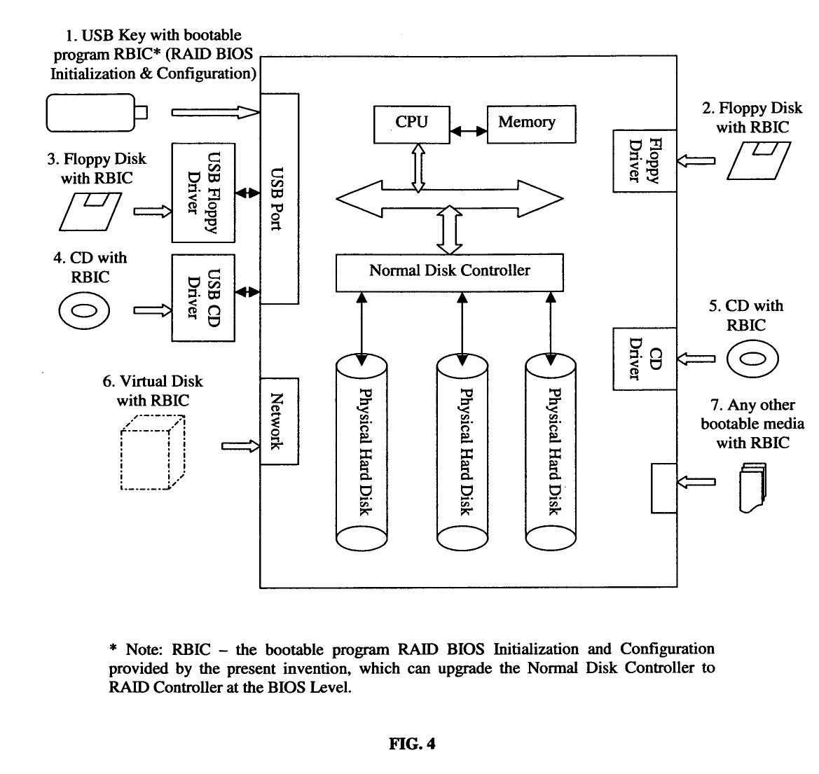

FIG. 4 shows the ways of the present invention how to upgrade a computer system with Normal Disk Controller to the system with RAID Controller at BIOS Level. The bootable program RBIC (RAID BIOS Initialization and Configuration) of the present invention can hook up the BIOS interrupt INT 13h to a new program so that all Low Level Disk services will be handled exactly like what the RAID Controller handles. Since the new INT 13h program will be placed in the EBDA (Extended BIOS Data Area) memory, the RBIC also hooks up the BIOS interrupt INT 15h for E820 function. In order to upgrade the Normal Disk Controller to RAID Controller, FIG. 4 shows the ways to put the bootable program RBIC on USB key, Floppy Disk, CD, Virtual Disk of network, or any other bootable media, and select this bootable media as the booting device in the BIOS Setup. After system boot into this bootable media with RBIC, the RBIC will take the control to hook up INT 13h and INT 15h and pass the control back to the system after upgrading. So, via a bootable media with RBIC program, the present invention can easily upgrade the Normal Disk Controller to RAID Controller at the BIOS Level.

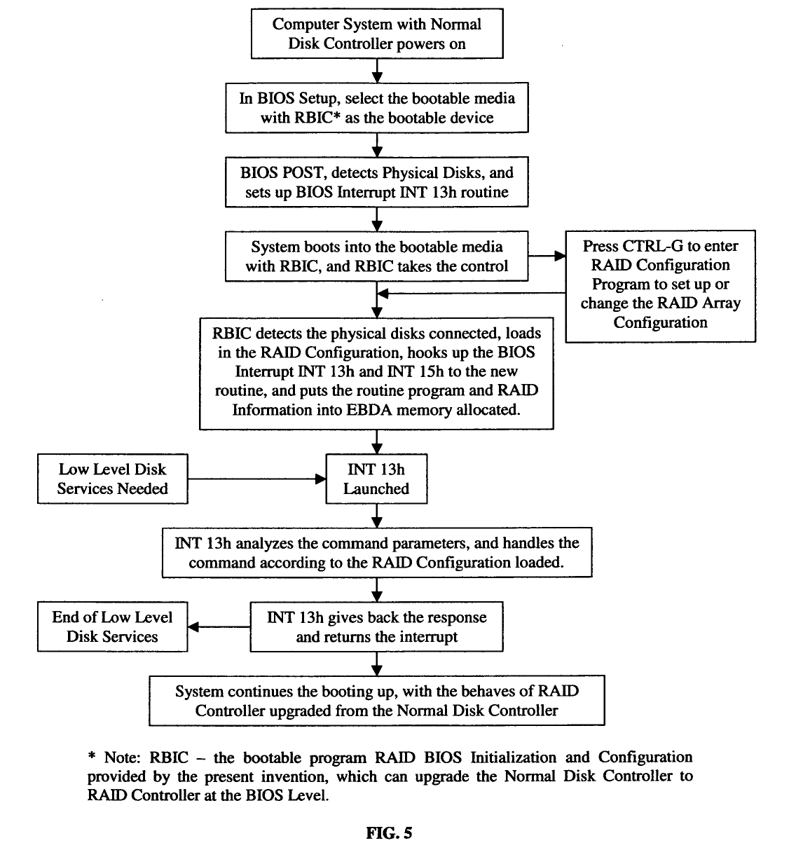

FIG. 5 illustrates how a computer system with RAID Controller, upgraded from the Normal Disk Controller, provides the Low Level Disk services at BIOS Level via INT 13h. In order to upgrade the Normal Disk Controller to RAID Controller as the present invention disclosed, a bootable media with RBIC program is needed to insert into the system, and it is also selected as the booting device in the BIOS Setup. After the computer system powers on, the BIOS POST (Power On and Self Test) will take the control first to detect the physical disks connected and set up BIOS Interrupt INT 13h routine as normal. After the system boots up into the bootable media with RBIC, the BIOS will pass control to RBIC program. RBIC will initialize the Controller, detect the physical disks connected, load in the RAID Configuration from the DDF Structure stored on the physical disks if there is a valid one, hook up the BIOS Interrupt INT 13h and INT 15h to the new routine, and put the routine program and RAID Information into EBDA memory allocated. RBIC will also give the chance for users to hit the specific key like CTRL-G to enter RAID Configuration menu for users to add or change the RAID Configuration. At last the RBIC will pass the control back to system to continue the booting up. If there is any Low Level Disk service needed, the only way to do it is still to call INT 13h to send the command and get the response. The new Interrupt INT 13h routine set up by the RBIC will be launched to analyze the command parameters. Based on the RAID Configuration information loaded, the new INT 13h might send the command to physical disks in the RAID array, get the responses back, process the results, set up the return value of interrupt, and return the interrupt to finish the Low Level Disk service.

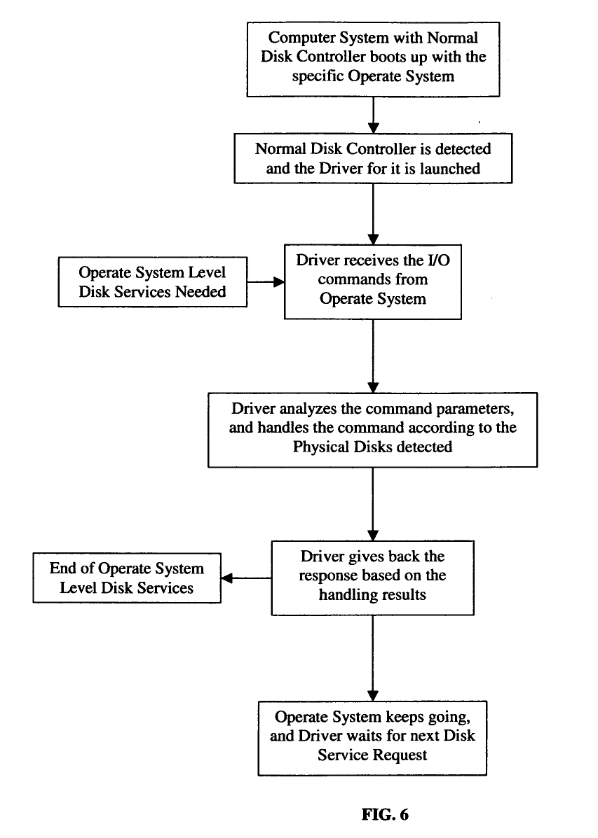

FIG. 6 illustrates how a computer system with Normal Disk Controller handles the commands of Disk services at Operate System Level via Driver. After the computer system with Normal Disk Controller boots up into Operate System, the Normal Disk Controller will be detect, and the Driver for Normal Disk Controller will be launched to take the control. The Normal Disk Controller Driver will initialize the Controller and detect the physical disks connected. If there is any Operate System Level Disk service needed, the Operate System will send the command to the Driver. After the Driver received the command, the Driver will analyze the command parameters, send the command to the specific physical disk, get the response, and send the result back to Operate System to finish the Operate System Level Disk service. Then the Driver will notify the Operate System that it is ready for the next command.

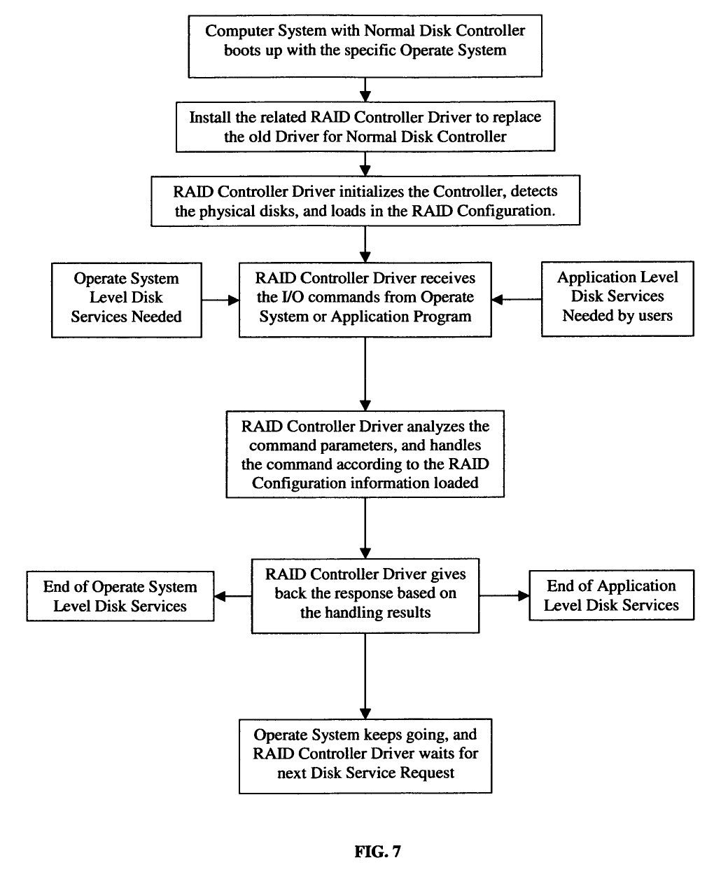

FIG. 7 illustrates how a computer system with RAID Controller, upgraded from the Normal Disk Controller through the Driver of the present invention, handles the commands of Disk services at Operate System Level. In order to upgrade the Normal Disk Controller to RAID Controller at the Operate System level, the RAID Controller Driver of the present invention needs to be installed to replace the default Driver for Normal Disk Controller. Therefore, after the computer system boots up into Operate System, the Controller will be detect, and the RAID Controller Driver will be launched to take the control. The RAID Controller Driver will initialize the Controller, detect the physical disks connected, and load in the RAID Configuration information from the DDF Structure stored in the physical disks if there is a valid one. Then the RAID Controller Driver is ready to receive the commands from Operate System or Application Program. If there is any Operate System Level Disk service needed, the Operate System will send the command to the Driver. If users have some disk service requests, the Application Program can help users to send the specific command to the Driver. After the RAID Controller Driver received the command, the Driver will analyze the command parameters. Based on the RAID Configuration information loaded, the RAID Controller Driver might send the command to physical disks in the RAID array, get the responses back, process the results, set up the return value, and send the final result back to Operate System or Application Program to finish disk service. Then the Driver will notify the Operate System that it is ready for the next command.

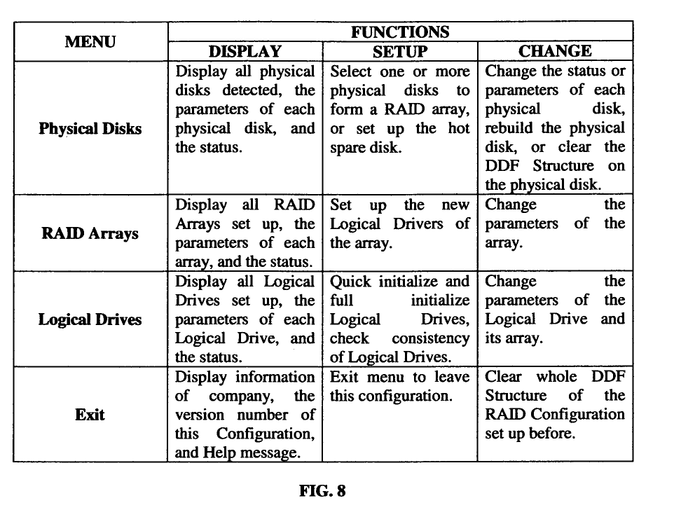

FIG. 8 illustrates RAID Configuration Menu and Functions of the present invention. After the computer system powers on, the RBIC program of the present invention displays a hint message for users to press the specific key like CTRL-G during the specific period to enter RAID Configuration Menu. The RAID Configuration Menu gives users the chance to set up the new RAID Configuration or change the existed RAID Configuration before the system boots into any Operate System. Actually the RAID Configuration Menu can finish all functions that a Hardware RAID Card can provide and more.

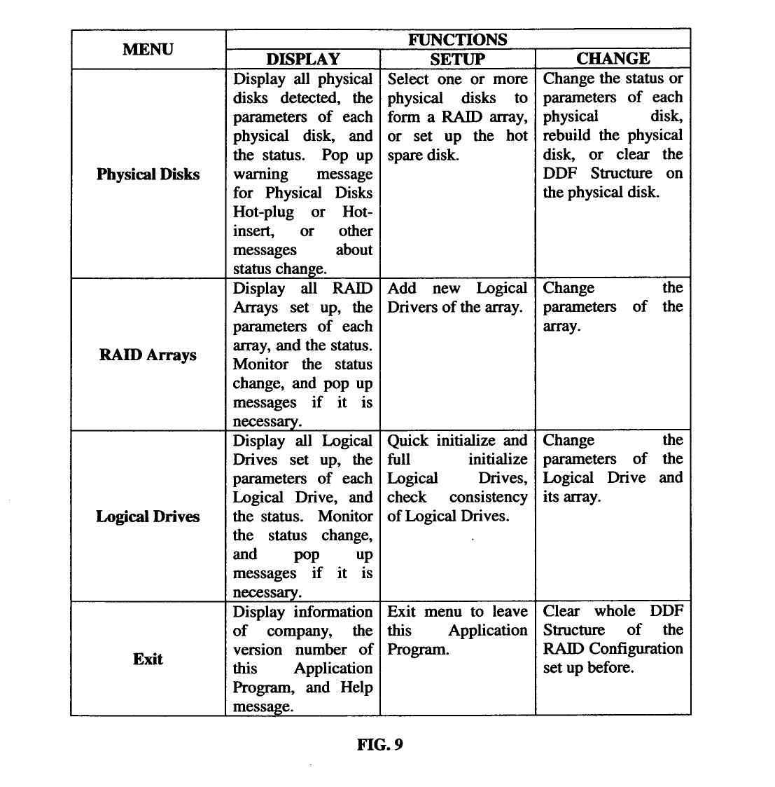

FIG. 9 illustrates the Application Program Menu and Functions of the present invention. Application Program realizes the similar function as the RAID Configuration Menu, but the Application Program can also real-time monitor the statuses of physical disks, RAID arrays and logical drives, and pop up message about status changes if it is necessary. The Application Program of the present invention gives users the power to set up the new RAID Configuration, to change the existed RAID configuration, and to handle the Hot-plug and Hot-insert after the system boots into the Operate System. Compared to the Application Program provided by the normal Hardware RAID Card, the Application Program of the present invention can realize more functions, and it is also a more user-friendly utility.

Anyway, the present invention provides a way to upgrade the Normal Disk Controller to RAID Controller. No mater from BIOS level, Operate System level, or Application level, the Controller after upgrading with the present invention will behave exactly like a RAID Controller, take the whole benefits of RAID, and more importantly, needn't any expensive RAID Card.

What is claimed is:

1. A method of upgrading Normal Disk Controller to RAID (Redundant Array of Independent Disks) Controller, wherein the said method comprises the parts of: a) RAID BIOS (Basic Input/Output System) Initialization and Configuration; b) Operate System Driver, c) Application Program.

2. The method of claim 1, wherein the said Normal Disk Controller further comprises all kinds of disk controllers, such as SCSI (Small Computer System Interface), SAS (Serial Attached SCSI), iSCSI (Internet SCSI), ATA (AT Attachment), SATA (Serial ATA), PATA (Parallel ATA), USB (Universal Serial Bus), Fiber, and even Network controllers, etc.

3. The method of claim 1, wherein the said RAID Controller is further upgraded from one or more different kinds of the said Normal Disk Controllers above.

4. The method of claim 1, wherein the part (a) of RAID BIOS Initialization and Configuration further comprises the steps of: a) storing the RAID BIOS Initialization and Configuration program into a bootable media, such as USB key, floppy disk, hard disk, or CD (Compact Disc) etc; b) selecting the said bootable media above as the boot device in BIOS Setup; c) running into RAID BIOS Initialization and Configuration program after system booting up; d) entering RAID Configuration Menu if the specified key like CTRL-G is hit to set up RAID Configuration; e) entering RAID BIOS Initialization to hook up BIOS Interrupt INT 13h and INT 15h based on RAID configuration so that BIOS level I/O commands could be handled by the updated INT 13h and INT 15h; f) passing the control to normal system booting.

5. The method of claim 4, wherein the step (d) of entering RAID Configuration Menu is skipped if the specified key hasn't been pressed during specific time period.

6. The method of claim 4, wherein the step (d) of entering RAID Configuration Menu to set up RAID Configuration further comprises all RAID Configuration functions, such as setting up new RAID Configuration, changing the parameters of the exist RAID Configuration, clearing up the old RAID Configuration, rebuilding Physical Disk of the array, checking consistence of Logical Unit, and initializing Logical Unit, etc.

7. The method of claim 4, wherein the result of the said RAID Configuration is further saved as DDF (Disk Data Format) Structure at the specific position of all physical disks participated in the RAID Arrays.

8. The method of claim 1, wherein the part (b) of Operate System Driver further comprises the steps of: a) installing the specific RAID Controller Driver under the specific Operate System; b) launching up the said Driver above automatically if the said Disk Controller detected; c) loading the RAID Configuration information by the said Driver above; d) translating and handling Operate System level I/O commands according to RAID Configuration; e) monitoring and reporting the status of Physical Disks; f) processing hot-plug and hot-insert of Physical Disk; f) handling the commands received from Application Level Program; g) updating RAID Configuration; h) sending the information back to Application Level Program; etc.

9. The method of claim 8, wherein the said Operate System includes all Windows Operate Systems, Linux, Unix, etc., but not DOS.

10. The method of claim 8, wherein the step (a) of installing the specific RAID Controller Driver could be done during Operate System Installation or after Operate System Installation.

11. The method of claim 1, wherein the part (c) of Application Program further comprises the functions of: a) providing menu interface for users to send commands; b) translating and handling the commands of users; c) sending the commands to Driver and getting the response; d) translating and displaying the response from Driver, e) monitoring the RAID system status from Driver and popping up warning message of events; etc.

12. The method of claim 11, wherein the function a) of providing menu interface for users further comprises the functions of: a) providing menu interface for users to realize the said all RAID Configuration functions above in the method of claim 6; b) providing menu interface for users to monitor and change the RAID system status; c) providing menu interface for users to display all RAID system information; etc.
